(19) United States
(12) Patent Application Publication
(10) Pub. No.: US 2016/0004897 A1
(43) Pub. Date: Jan. 7, 2016

(54) INTEGRATED FINGERPRINT SENSOR

(71) Applicant: IDEX ASA, Fornebu (NO)

(72) Inventors: Øyvind SLØGEDAL, HOSLE (NO); Ralph W. BERNSTEIN, HOSLE (NO); Geir Ivar BREDHOLT, OSLO (NO)

(73) Assignee: IDEX ASA, FORNEBU (NO)

(21) Appl. No.: 14/768,654

(22) PCT Filed: Feb. 21, 2014
(86) PCT No.: PCT/EP2014/053403

§ 371 Date: Aug. 18, 2015

(30) Foreign Application Priority Data
Feb. 22, 2013 (NO) 20130289

(51) Int. Cl. G06K 9/00; G06F 21/32; H04W 4/00; H04M 1/725; G06F 3/041; G06F 1/16

(52) U.S. Cl. CPC G06K 9/00013; G06K 9/0002; G06K 9/00053; G06F 3/0412; G06F 1/1613; G06F 1/169; H04W 4/008; H04M 1/72519; G06F 21/32

(57) ABSTRACT

This invention relates to a fingerprint sensor especially for integration in a unit having a cover material such as glass being transparent in a certain area, the fingerprint sensor comprising a number of electrodes positioned in a predetermined pattern on or close to the surface of said cover material, each electrode being connected to a conductor lead extending through said cover material, the conductor lead being essentially transparent and being routed on the opposite side from the electrodes to a processing unit being positioned outside said transparent area.

This invention relates to a fingerprint sensor for integration in smart phones or similar.

Finger print sensors comprising electrodes for measuring characteristics in a finger surface are well known, eg EP0988614, U.S. Pat. Nos. 5,963,679 and 6,069,970 describe sensors based on different measuring impedance or capacitance principles with stripe shaped or matrix sensors comprising a number of individual sensor elements.

A disadvantage with the abovementioned sensors is, however the sensor surfaces are not suitable for having direct contact with the environment, and usually has to be provided with a housing protecting the circuits from humidity, wear, corrosion, chemical substances, electronic noise, mechanical influences, sun light electric discharges etc. U.S. Pat. No. 5,862,248 provides a possible solution to this problem, in which the circuit is enclosed in such a way that the finger is allowed to direct contact with the sensitive surface of the sensor through an opening in the top of the enclosure. In many cases this solution will not sufficient to provide the required reliability. The materials (metal, dielectrics) being used on the surface of the integrated circuits are usually not sufficiently reliable to withstand exposure from the outer environment and contact with the finger over a longer period of time, and thus this solution will also lead to reliability problems. Another solution may be adding additional layers of metal and dielectrics on the chip surface, as described in U.S. Pat. No. 6,069,970. Such layers will however, increase the production costs and create compatibility problems with the semiconductor process in general (related to processing temperature, varying dimensions due to temperature differences etc). Yet another solution is described in U.S. Pat. No. 7,251,351 leading the conductors through a substrate to the processor then being positioned safely on the back side of the substrate, inside the device. This solution is not easily implemented in smart phones requiring large, transparent panels.

In US2011/0182488 also describes a fingerprint sensor in which the processing unit is positioned on one side of s substrate and there are conductors leading through the substrate to the other side. The substrate is a semi conducting material and the conductors are made from the same material being insulated from the substrate. U.S. Pat. No. 6,327,376 on the other hand described a transparent substrate carrying transparent conductors, evidently positioned on the same side of the substrate as the sensor, thus making it vulnerable to wear.

The object of this invention is to secure a cost effective miniature sensor solution both eliminating the technical risk at exposing of the sensor to the external environment, which may be realized in smart phones with touch screen interfaces. It is also an object of the present invention to provide a solution for touch screen driven units such as smart phones with few, if any, additional buttons, where space is becoming very limited on front surface of phones where the display area is approaching 100% utilization. These objects are obtained as disclosed in the independent claims.

This way it is possible to integrate a fingerprint swipe sensor in the shell of a mobile phone, especially through the front glass or protective covering of a smart phone, taking the design and ergonomics are key design criteria for different handset manufacturers.

The present invention will be described in more detail with reference to the accompanying drawings, illustrating the invention by way of example.

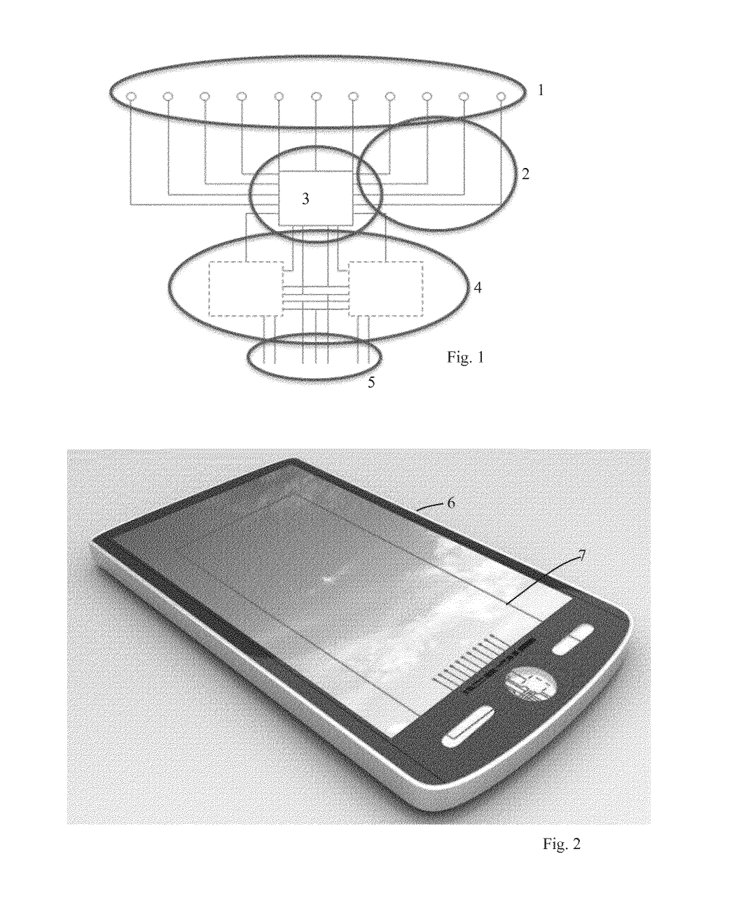

FIG. 1 illustrates the layout of the circuitry according to the invention.

FIG. 2 illustrates the invention implemented into a smart phone.

As illustrated in FIG. 1 a set of electrodes 1 are provided having a first end extending through the casing or glass covering a unit such as a smart phone, where the electrodes provide electric coupling with the finger surface enabling the measuring of the fingerprint etc. If a stripe sensor is used a number of additional sensors may be employed for measuring the finger movement relative to the sensor as discussed in the abovementioned EP0988614 or U.S. Pat. No. 7,251,351. Alternatively the sensor may be a partial matrix sampling a sequence of images of the surface as in U.S. Pat. No. 6,289,114. Yet another electrode constellation is described in EP1328919 where two lines of sensor elements are used for measureing the movement of a finger for navigation purposes.

A full sensor matrix covering the complete, immobile finger, may also be contemplated but at the disadvantage of the number of electrodes necessary.

As stated above the conductor leads 2 from the electrodes are lead vertically through the cover material then laterally routed or redistributed to a signal processor 3, e.g. for analog signal conditioning, being positioned on the rear side of the cover. This may be a CMOS ASIC. Vertical and lateral conductor leads may be fashioned in such a way that small feature size or transparent materials such as Indium Tin Oxide (ITO) renders the conductors invisible to the user. Standard metal routing and via processing are available for this. Electrodes and associated conductor leads may be processed partially on the front or back side of the glass, or on additional intermittent planes in between.

The unit may also include optional silicon dies and circuitry 4 for secure biometric authentication . Typical options include microcontrollers for running biometric algorithms and communication and other functions requiring logic processing, various secure elements and USIM chips for authorizing financial transactions or service providere identification, as well as NFC controllers for radio frequency communication.

As illustrated the unit also may include an interface 5 to other parts of the smart phone or external connectors and equipment. An antenna (not shown) is also possible to integrate in combination with an NFC controller.

Thus is possible to integrate a fingerprint swipe sensor in the shell of a mobile phone while taking into account design and ergonomics are key design criteria for handset manufacturers. This will provide additional advantages such as:
Design
Ergonomics and usability
Simplified integration and enhanced durability
User feedback for increased biometric performance
Direct interaction with application graphics and animations

FIG. 2 illustrates a smart phone 6 where the unit according to the invention is implemented in a phone using standard smartcard controllers and NFC chip set with antenna and combined to emulate an autonomous, biometric, standard EMV card in the cover glass 7.

Thus the invention relates to a fingerprint sensor especially for integration in a unit having a cover material such as glass being transparent in a certain area. The fingerprint sensor comprises a number of electrodes positioned in a predetermined pattern on or close to the surface of said cover material. This may be made by locally reducing the cover thickness or ny additional layers on the cover and electrodes so as to obtain a galvanic or capacitive coupling to the finger surface. Each electrode is connected to a conductor lead extending through or almost through said cover material, the conductor lead being essentially transparent and being routed on the opposite side from the electrodes to a processing unit being positioned outside said transparent area.

Additional circuitry for authentication means connected to said processor, as well as interface means for communication with other circuitry in the unit. These may also include a display for communicating indications to the user resulting from the fingerprint scan.

1. Fingerprint sensor for integration in a unit having a cover material made of glass being transparent in a certain area, the fingerprint sensor comprising a number of electrodes positioned in a predetermined pattern on or close to a surface of said cover material, each electrode being connected to a conductor lead extending through said cover material, the conductor lead being essentially transparent and being routed on the opposite side from the electrodes to a processing unit being positioned outside said transparent area.

2. The fingerprint sensor according to claim 1, including additional circuitry connected to said processing unit and configured to perform biometric authentication.

3. The fingerprint sensor according to claim 1 including an interface configured for communication with other circuitry in the unit.

4. (canceled)

5. The fingerprint sensor of claim 1, wherein the predetermined pattern of the electrodes forms a stripe sensor, and the fingerprint sensor further comprises a number of additional sensors configured to measure finger movement relative to the fingerprint sensor.

6. The fingerprint sensor of claim 1, wherein the electrodes form a partial matrix sampling a sequence of images of a finger surface.

7. The fingerprint sensor of claim 1, wherein the electrodes form two lines of sensor elements configured for measuring the movement of a finger for navigation purposes.

8. The fingerprint sensor of claim 1, wherein the conductor leads extend vertically through the cover material and laterally to the processing unit.

9. The fingerprint sensor of claim 2, wherein the additional circuitry comprises microcontrollers configured to execute biometric algorithms.

10. The fingerprint sensor of claim 2, wherein the additional circuitry comprises a USIM chip configured for authorizing financial transactions or for service provider identification.

11. The fingerprint sensor of claim 2, wherein the additional circuitry comprise an NFC controller configured for radio frequency communication.

12. A communication device comprising:
a cover material made of glass and transparent in a certain area; and
an fingerprint sensor integrated into the cover material and comprising:
a number of electrodes on or close to a surface of a portion of the transparent area of the cover material and forming a fingerprint sensing area on the surface of the cover material;
a processing unit positioned outside the transparent area of the cover material on a side of the cover material opposite the electrodes; and
essentially transparent conductor leads, wherein each electrode is connected to the processing unit by a conductor lead extending through the cover material and routed on the opposite side of the cover material.

13. The communication device of claim 12, further including additional circuitry connected to the processing unit and configured to perform biometric authentication.

14. The communication device of claim 12, further including an interface configured for communication between the processing unit and other circuitry in the communication device.

15. The communication device of claim 14, wherein the other circuitry in the communication device comprises a display for communicating indications to the user resulting from a fingerprint scan by the fingerprint sensor.

16. The communication device of claim 12, wherein the electrodes forms a stripe sensor, and the fingerprint sensor further comprises a number of additional sensors configured to measure finger movement relative to the fingerprint sensor.

17. The communication device of claim 12, wherein the electrodes form a partial matrix sampling a sequence of images of a finger surface.

18. The communication device of claim 12, wherein the electrodes form two lines of sensor elements configured for measuring the movement of a finger across a portion of the cover material.

19. The communication device of claim 12, wherein the conductor leads extend vertically through the cover material and laterally to the processing unit.

20. The communication device of claim 13, wherein the additional circuitry comprises microcontrollers configured to execute biometric algorithms.

21. The communication device of claim 13, wherein the additional circuitry comprises a USIM chip configured for authorizing financial transactions or for service provider identification.

22. The communication device of claim 13, wherein the additional circuitry comprises an NFC controller configured for radio frequency communication.

23. The communication device of claim 12, wherein the processing unit comprises a CMOS ASIC.

24. The communication device of claim 12, wherein substantially 100% of the cover material comprises a display area.
